(19) United States
(12) Patent Application Publication
(10) Pub. No.: US 2017/0337500 A1
(43) Pub. Date: Nov. 23, 2017

(54) METHOD AND APPARATUS FOR A MOBILE POST-WIRE CABLE COMMUNICATION INSTALLATION AND SERVICE ASSISTANCE CALL-UP APPLICATION

(71) Applicant: Decisive Communications, Inc., Ijamsville, MD (US)

(72) Inventor: Timithy B. Harwood, Ijamsville, MD (US)

(73) Assignee: Decisive Communications, Inc., Ijamsville, MD (US)

(21) Appl. No.: 15/494,582

(22) Filed: Apr. 24, 2017

Related U.S. Application Data
(60) Provisional application No. 62/326,854, filed on Apr. 25, 2016.

(51) Int. Cl. G06Q 10/06; G06Q 10/10; G06F 3/048; G06Q 10/00

(52) U.S. Cl. CPC G06Q 10/063112; G06Q 10/20; G06Q 10/1097; G06F 3/048; G06Q 10/063114; G06Q 10/06316

(57) ABSTRACT

A system and a computer implemented method for dispatching technical assistance to a technician comprises a memory unit, and a processor. The memory unit stores location references associated with the at least one technician. The set of program modules comprises an input module and an assistance module. The input module is configured to receive from a first technician, a request for technical assistance, and a first location reference associated with the first technician. The assistance module, is configured to notify the at least one technician about the request from the first technician, based on locations referenced by the at least one location reference being within a first distance range from locations referenced by the first location reference, and receive a response message from the at least one technician. The assistance module is enabled to assign the task to the at least one technician, and increase the first distance range incrementally.

### CROSS REFERENCE TO APPLICATION

This patent application claims the benefit of U.S. Provisional Application, App. No. 62/326,854, filed on Apr. 25, 2016. The above application is incorporated by reference herein in its entirety.

### FIELD OF THE INVENTION

The present invention relates to a method and apparatus for a mobile post-wire cable communication installation and services assistance call-up application, and, more particularly, to a method and apparatus for a mobile application that allows for the call-up of additional technical assistance for the installation and/or service of cable communication lines.

### BACKGROUND OF THE INVENTION

Mobile applications have pervaded every aspect of life in the twenty first century. Examples of the on-demand mobile applications include but are not limited to Repair Pal, Uber, and Showaround. Today, users access the on-demand mobile applications for multiple purposes. As often is the case, users access the mobile applications to acquire information about nearby restaurants, lodges, electronics showrooms, and car repair centers. Further, the users access the mobile applications to connect with service providers having expertise in a plurality of fields. Potentially, mobile applications have a wide gamut of practical applications in optimizing logistical and technical processes involved in successful delivery of services by the service providers.

To cite an example, service related industries such as cable installation industry heavily rely on work done by technicians working in field. The technicians often require technical assistance from other technicians in the field. The mobile applications have the potential to be used to automate and thereby optimize dispatch of technical assistance to technicians. Presently, service providers dispatch technical assistance to the technicians manually. Today, manual dispatch of technical assistance to the technicians is resulting in extensive losses in time and money for the service providers.

Therefore, there is a need in the art for a system and computer implemented method for dispatching technical assistance to a technician.

### SUMMARY OF THE INVENTION

The present invention relates to a system and computer implemented method for dispatching technical assistance to a technician.

In one embodiment of the present invention, a system for dispatching technical assistance to a technician comprises a memory unit and a processor. The memory unit stores at least one location reference associated with the at least one technician, and a set of program modules. The processor executes the set of program modules. The set of program modules comprises an input module and an assistance module. The input module is configured to receive from a first technician, a request for technical assistance, and a first location reference associated with the first technician. The request comprises a description of technical assistance required by the first technician. The assistance module, is configured to notify the at least one technician about the request from the first technician, based on locations referenced by the at least one location reference being within a first distance range from locations referenced by the first location reference. Further, the assistance module transmits the description of the task to the at least one technician, and receives a response message from the at least one technician. The response message comprises one of acceptance by the at least one technician to perform the task and rejection by the at least one technician to perform the task. Further, the assistance module assigns the task to the at least one technician, based on the response message comprising acceptance to perform the task, and increases the first distance range incrementally, based on the response message comprising rejection to perform the task.

In one embodiment of the present invention, location references are at least one of a Cartesian coordinate based location reference and a Global Positioning System (GPS) coordinate based location reference. Further, the at least one technician is a post wire technician. Furthermore, the assistance module notifies the at least one technician via push notification. Moreover, the input module receives the request via at least one user terminal. The at least one user terminal is at least one of a computer, a laptop, a palm top, a tablet computer, and a smart phone. The set of program module further comprises an override module configured to reassign the task to a supervisor personnel.

In another embodiment of the present invention, a computer implemented method for dispatching technical assistance to a technician comprises storing in a memory unit, at least one location reference associated with the at least one technician, and a set of program modules. Further, the method comprises receiving from a first technician, by the processor via an input module, a request for technical assistance, and a first location reference associated with the first technician. The request comprises a description of technical assistance required by the first technician. The method comprises notifying by the processor via an assistance module, the at least one technician about the request from the first technician, based on locations referenced by the at least one location reference being within a first distance range from locations referenced by the first location reference. Furthermore, the method comprises transmitting by the processor via the assistance module, the description to the at least one technician. Moreover, the method comprises receiving by the processor via the assistance module, a response message from the at least one technician, wherein the response message comprises one of acceptance by the at least one technician to perform the task and rejection by the at least one technician to perform the task. Furthermore, the method comprises assigning, by the processor via the assistance module, the task to the at least one technician, based on the response message comprising acceptance to perform the task. Moreover, the method comprises increasing by the processor via the assistance module, the first distance range incrementally, based on the response message comprising rejection to perform the task.

### BRIEF DESCRIPTION OF THE DRAWINGS

FIG. 1 is a block diagram of an environment in accordance with which various embodiments of the present invention are implemented.

FIG. 2 illustrates a screenshot of the opening start-up and/or log-in page that a first technician would receive/see of the Post-Wire install/service mobile application, according to an embodiment of the present invention.

FIG. 3 illustrates a screenshot of the “current location & request help” page that the first technician would receive/see of the Post-Wire install/service mobile application, according to an embodiment of the present invention.

FIG. 4 illustrates a screenshot of the “request-in-progress” page that the first technician would receive/see of the Post-Wire install/service mobile application, according to an embodiment of the present invention.

FIG. 5 illustrates a screenshot of the “request sent” page that the first technician would receive/see of the Post-Wire install/service mobile application, according to an embodiment of the present invention.

FIG. 6 illustrates a screenshot of the “request notification” page that the first quality control (QC) post-wire technician would receive/see of the Post-Wire install/service mobile application, according to an embodiment of the present invention.

FIG. 7 illustrates a screenshot of the “accept/reject alert request” page that the first QC post-wire technician would receive/see of the Post-Wire install/service mobile application, according to an embodiment of the present invention.

FIG. 8 illustrates a screenshot of the “technician rejection alert request” page that the first QC post-wire technician would receive/see of the Post-Wire install/service mobile application, according to an embodiment of the present invention.

FIG. 9 illustrates a screenshot of the “technician rejected alert request” page that the first technician would receive/see of the Post-Wire install/service mobile application, according to an embodiment of the present invention.

FIG. 10 illustrates a screenshot of the “all rejection or time-out” page that the first technician would receive/see of the Post-Wire install/service mobile application, according to an embodiment of the present invention.

FIG. 11 illustrates a screenshot of the “larger area request-in-progress” page that the first technician would receive/see of the Post-Wire install/service mobile application, according to an embodiment of the present invention.

FIG. 12 illustrates a screenshot of the “larger area request sent” page that the first technician would receive/see of the Post-Wire install/service mobile application, according to an embodiment of the present invention.

FIG. 13 illustrates a screenshot of the “accept/reject alert request” page that the second QC post-wire technician would receive/see of the Post-Wire install/service mobile application, according to an embodiment of the present invention.

FIG. 14 illustrates a screenshot of the “technician accept alert request” page that the first technician would receive/see of the Post-Wire install/service mobile application, according to an embodiment of the present invention.

FIG. 15 illustrates a screenshot of the “assistance-en-route” page that the first technician would receive/see of the Post-Wire install/service mobile application, according to an embodiment of the present invention.

FIG. 16 illustrates a screenshot of the “alert request already accepted” page that the third QC post-wire technician would receive/see of the Post-Wire install/service mobile application, according to an embodiment of the present invention.

FIG. 17 illustrates a screenshot of the “supervisor override” page that the supervisor of the first technician would receive/see of the Post-Wire install/service mobile application, according to an embodiment of the present invention.

FIG. 18 illustrates a screenshot of the “supervisor override change” page that the second QC post-wire technician would receive/see of the Post-Wire install/service mobile application, according to an embodiment of the present invention.

FIG. 19 illustrates a screenshot of the “supervisor override” page that the second QC post-wire technician would receive/see of the Post-Wire install/service mobile application, according to an embodiment of the present invention.

FIG. 20 illustrates a screenshot of the “supervisor override change” page that the first technician would receive/see of the Post-Wire install/service mobile application, according to an embodiment of the present invention.

FIG. 21 illustrates a screenshot of the “supervisor assistance-en-route” page that the first technician would receive/see of the Post-Wire install/service mobile application, according to an embodiment of the present invention.

FIG. 22 illustrates a screenshot of the “supervisor assistance-en-route update” page that the first technician would receive/see of the Post-Wire install/service mobile application, according to an embodiment of the present invention.

FIG. 23 illustrates a screenshot of the “multiple accept/reject alert request” page that the first QC post-wire technician would receive/see of the Post-Wire install/service mobile application, according to an embodiment of the present invention.

FIG. 24 is a flowchart of a method of dispatching technical assistance to a technician, according to an embodiment of the present invention.

### DETAILED DESCRIPTION

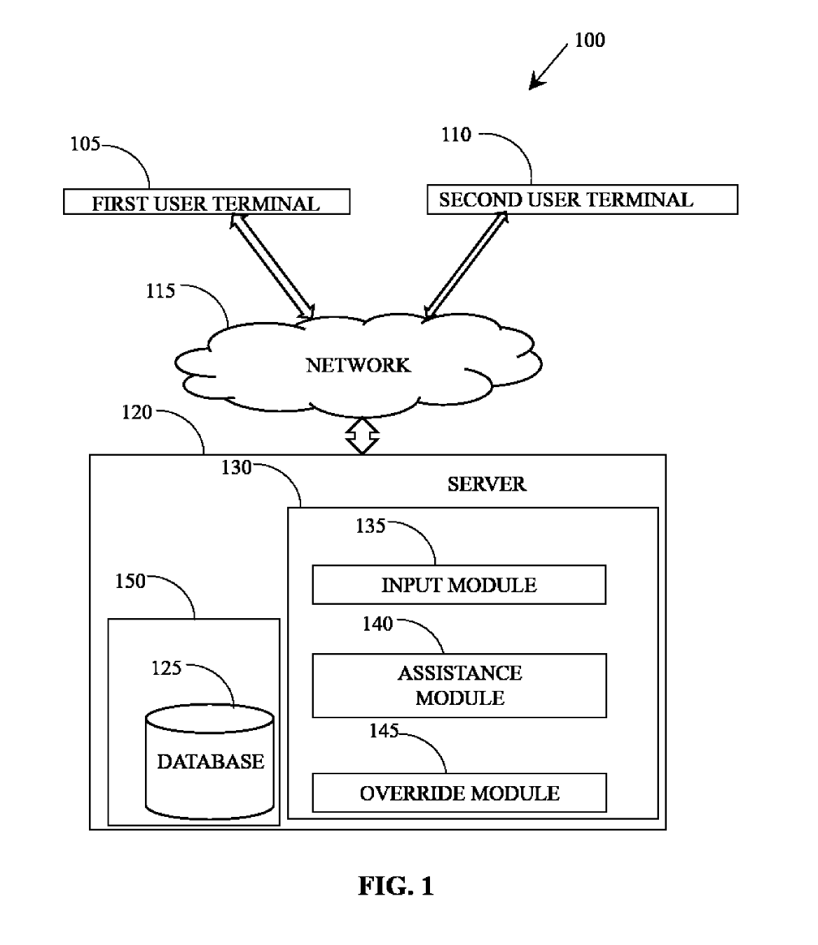

FIGS. 1 through 24 illustrate a method and apparatus for a mobile application that allows for the call-up of additional technical assistance for the installation and/or service of cable communication lines.

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

FIG. 1 is a block diagram of an environment 100 in accordance with which various embodiments of the present invention are implemented. The environment 100 comprises a first user terminal 105, a second user terminal 110 and a server 120. The first user terminal 105, the second user terminal 110, and the server 120 are connected with each other via a network 115. The network 115 is at least one of a Local Area Network, a wide area network 115, and a mobile network 115. The environment hosts a system for dispatching technical assistance to a first technician in the server 120. The first technician and a second technician communicates with the system, via at least one of the first user terminal 105 and the second user terminal 110. The first user terminal 105 and the second user terminal 110 are at least one of personal computers, laptops, smartphones, tablet computers, and personal digital assistants. In one example, a first portion of the system for dispatching technical assistance is implemented in the first user terminal 105 and the second user terminal 110 as a mobile application. In one example, the mobile application is a Post-Wire install/service mobile application.

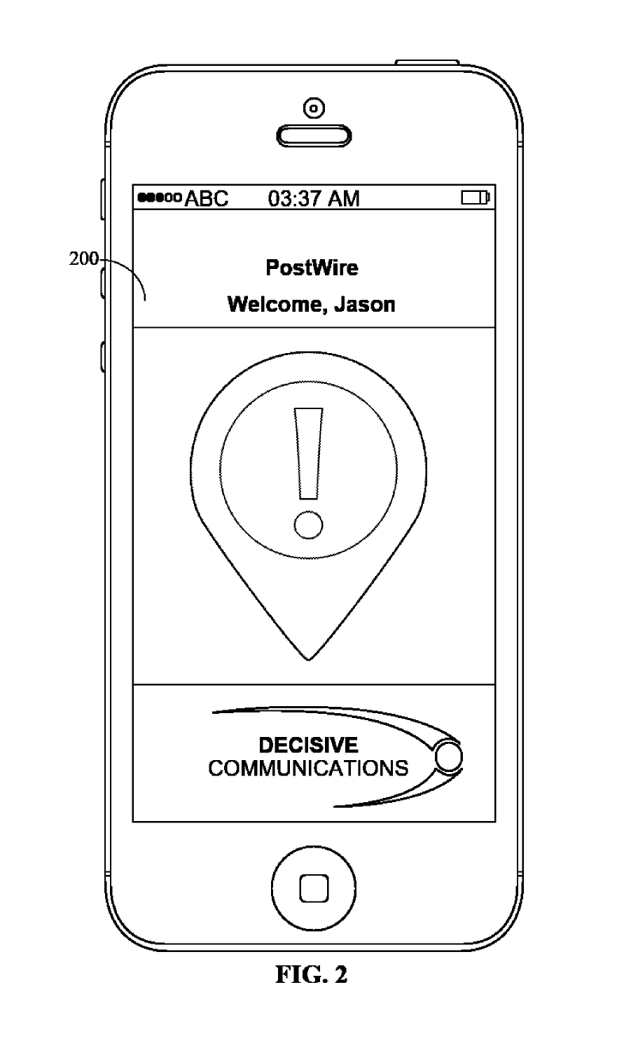

Referring now specifically to FIG. 2, a screenshot 200 of an opening start-up and/or log-in page that a first technician receives from the Post-Wire install/service mobile application is shown. The first technician sees the screenshot 200 upon commencement and/or launching of the Post-Wire install/service mobile application. The mobile application comprises information regarding the first technician, such as designation and roles of the first technician, based on the mobile device and/or computer/machine upon which it is installed. It is to be understood, of course, that such information can be pre-installed.

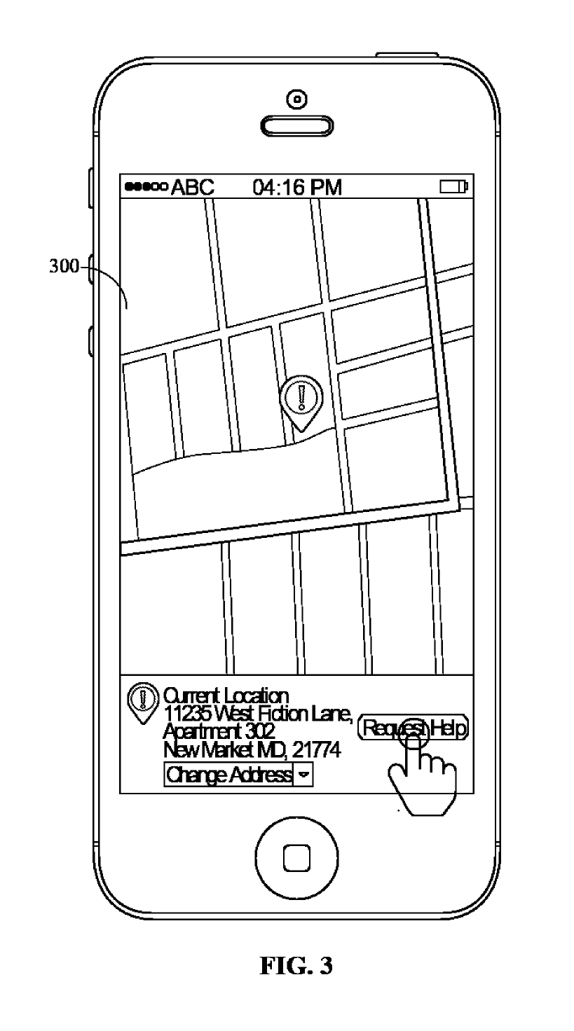

Referring now specifically to FIG. 3, a screenshot 300 of the “current location & request help” page that the first technician would receive/see of the Post-Wire install/service mobile application is shown. Referring to FIG. 1 again, in another example, the system for dispatching technical assistance is implemented in the server 120.

In one embodiment of the present invention, the server 120 comprises a memory unit 150 and a processor 130. The memory unit 150 stores at least one location reference associated with the at least one technician, and a set of program modules. In one example, the memory unit 150 comprises a database 125. The at least one location reference is at least one of a Cartesian coordinate based location reference and a Global Positioning System (GPS) coordinate based location reference. Further, in one example, the second technician is a post wire technician. The processor 130 executes the set of program modules. The set of program modules comprises an input module 135 and an assistance module 140. The input module 135 is configured to receive from the first technician, a request for technical assistance, and a first location reference associated with the first technician.

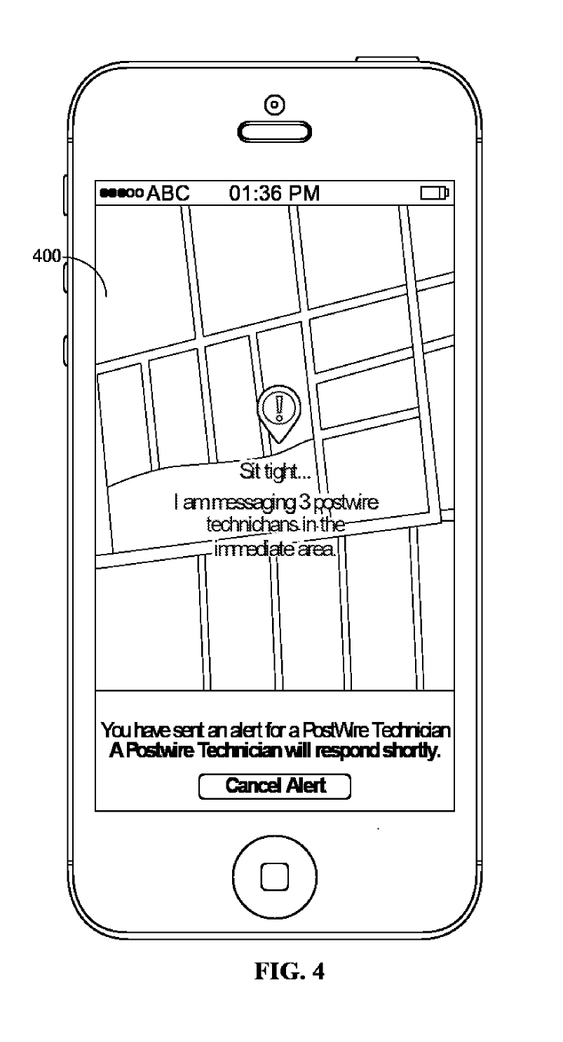

Referring now specifically to FIG. 4, a screenshot 400 of a “request-in-progress” page that the first technician would receive/see of a Post-Wire install/service mobile application is shown, according to an embodiment of the present invention. In one example, the screenshot 400 comprises a pictorial map of areas in vicinity of a first location. In one example, the areas in vicinity comprises areas within ten kilometers of the first location. In one example, the screenshot 400 comprises a message to the first technician. In one example, the message is “sit tight”.

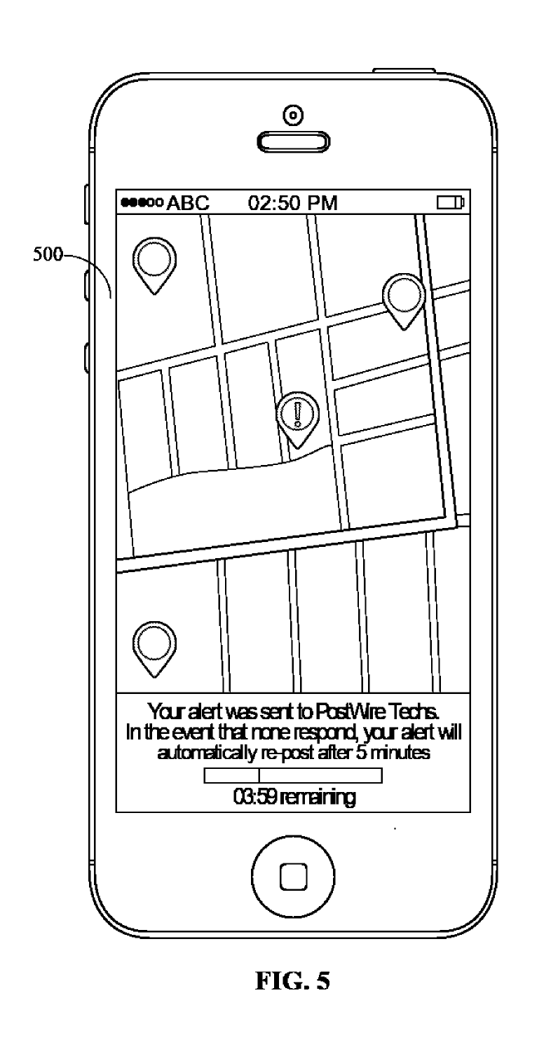

Referring now specifically to FIG. 5, a screenshot 500 of the “request sent” page that the first technician would receive/see of the Post-Wire install/service mobile application is illustrated, according to an embodiment of the present invention. The screenshot 500 comprises feedback represented by a progress indicator, and a status indicator. The feedback is important when the first technician is waiting. The progress indicator, and the status indicator alleviates anxiety and helps in properly setting expectations. The progress indicator enables the first technician to assert that the Post-Wire install/service mobile application is functioning and has not crashed. In another example, the screenshot 500 presents the first technician with locations of a plurality of technicians in vicinity of the first location. The plurality of technicians is located within a radius of miles around the first location. The first technician is enabled to one of accept and reject the request. Further, the screenshot 500 comprises a timer set to five minutes.

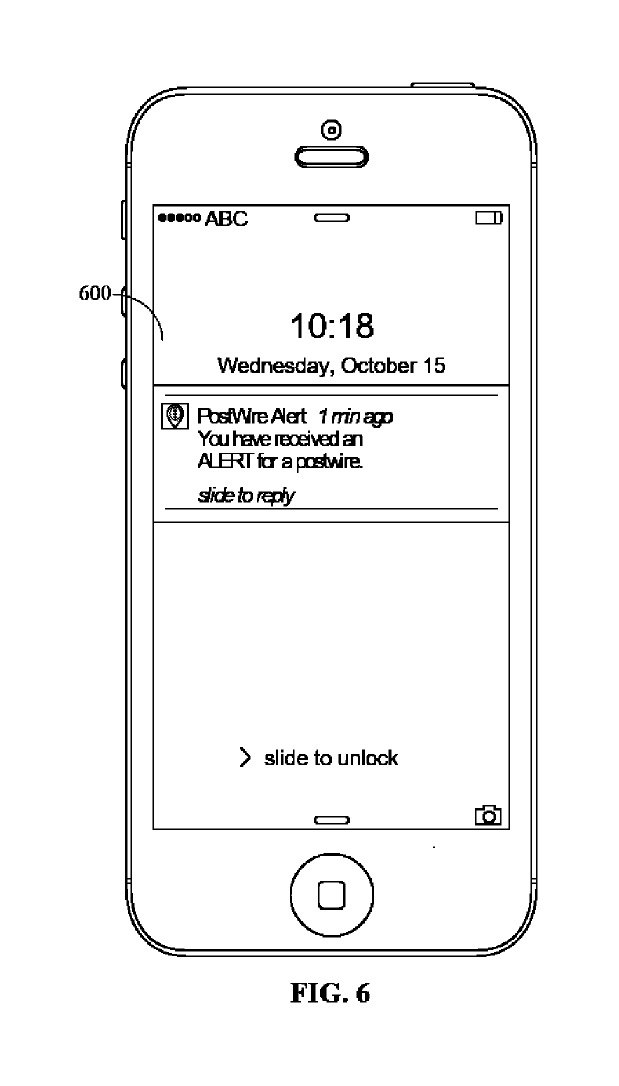

Referring to FIG. 1 again, the request comprises a description of technical assistance required by the first technician. The description is at least one of a textual description, a visual description, and a vocal description. If the locations referenced by the at least one location reference is within a first distance range from locations referenced by the first location reference, then the assistance module 140 notifies the at least one technician about the request from the first technician. The assistance module 140 notifies the at least one technician via push notification. FIG. 6 illustrates a screenshot 600 of the “request notification” page that the first quality control (QC) post-wire technician would receive/see of the Post-Wire install/service mobile application, according to an embodiment of the present invention. The QC post-wire technician receives the notification as a push-notification on home screen of a smart phone.

Referring to FIG. 1 again, Further, the assistance module 140 transmits the description of the task to the at least one technician, and receives a response message from the at least one technician. The response message comprises one of acceptance by the at least one technician to perform the task and rejection by the at least one technician to perform the task. Further, the assistance module 140 assigns the task to the at least one technician, based on the response message comprising acceptance to perform the task, and increases the first distance range incrementally, based on the response message comprising rejection to perform the task.

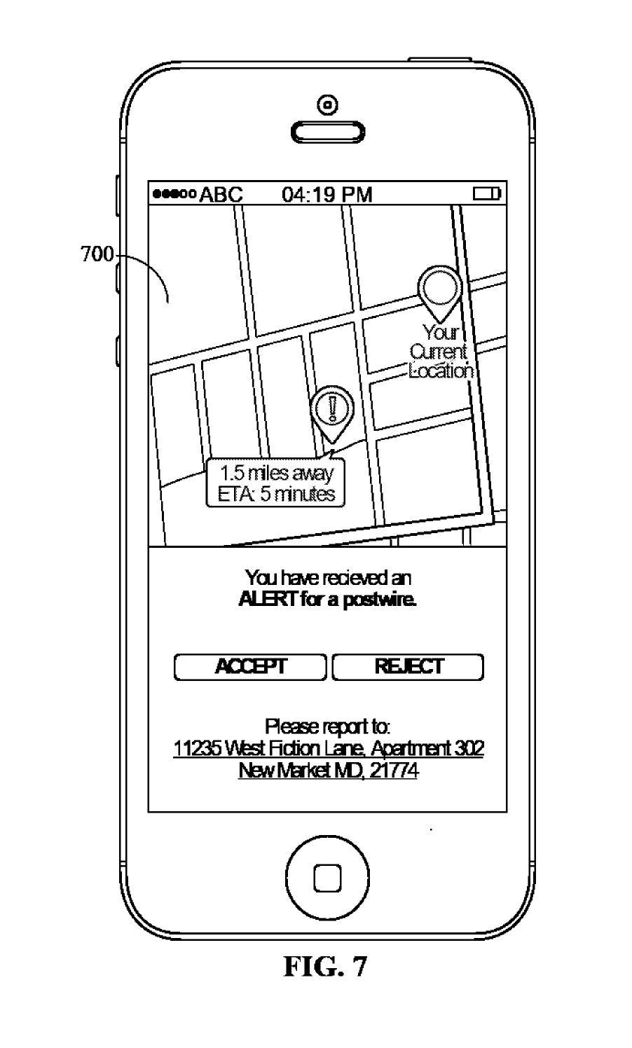

In one example, FIG. 7 illustrates a screenshot 700 of the “accept/reject alert request” page that the first QC post-wire technician would receive/see of the Post-Wire install/service mobile application, according to an embodiment of the present invention. When the first QC post-wire technician opens, the Post-Wire install/service mobile application, the first QC post-wire technician is presented with a map comprising locations of the first QC post-wire technician and a first technician. Further, the map presents the user with distance between the first QC post-wire technician and the first technician. In one example, the map is extracted from one of a GOOGLE′ maps application and an APPLE maps application. The first QC post-wire technician is enabled to one of accept and reject one or more requests received from the first technician. In one example, if the first QC post-wire technician accepts the one or more requests received from the first technician, then the first QC post-wire technician is awarded with an incentive.

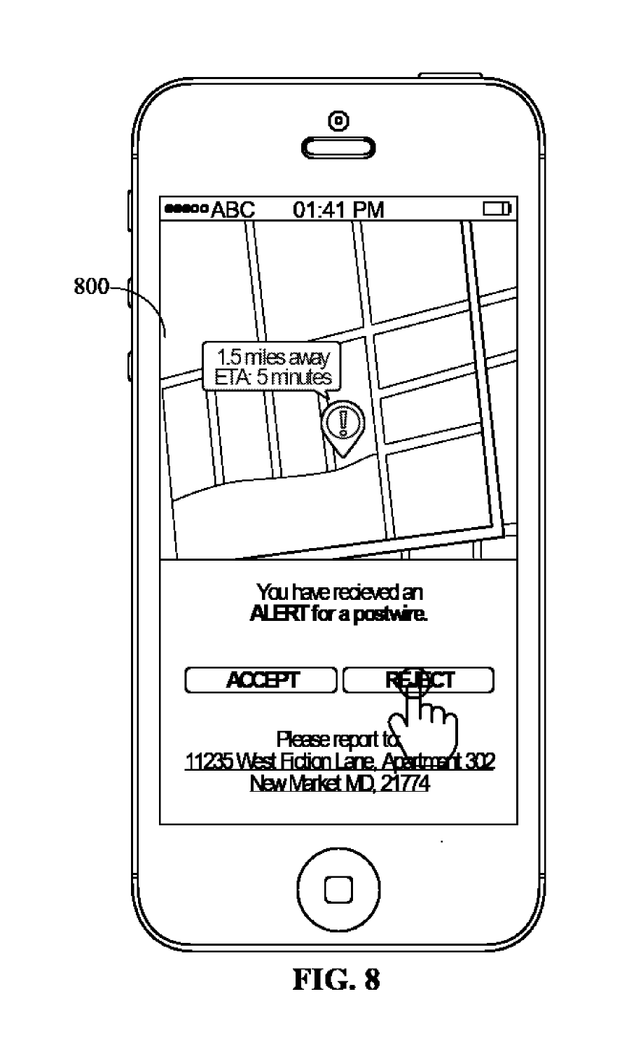

Referring now specifically to FIG. 8, FIG. 8 illustrates a screenshot 800 of the “technician rejection alert request” page that the first QC post-wire technician would receive/see of the Post-Wire install/service mobile application, according to an embodiment of the present invention. In another example, the first QC technician is enabled to reject the one or more requests received from the first technician.

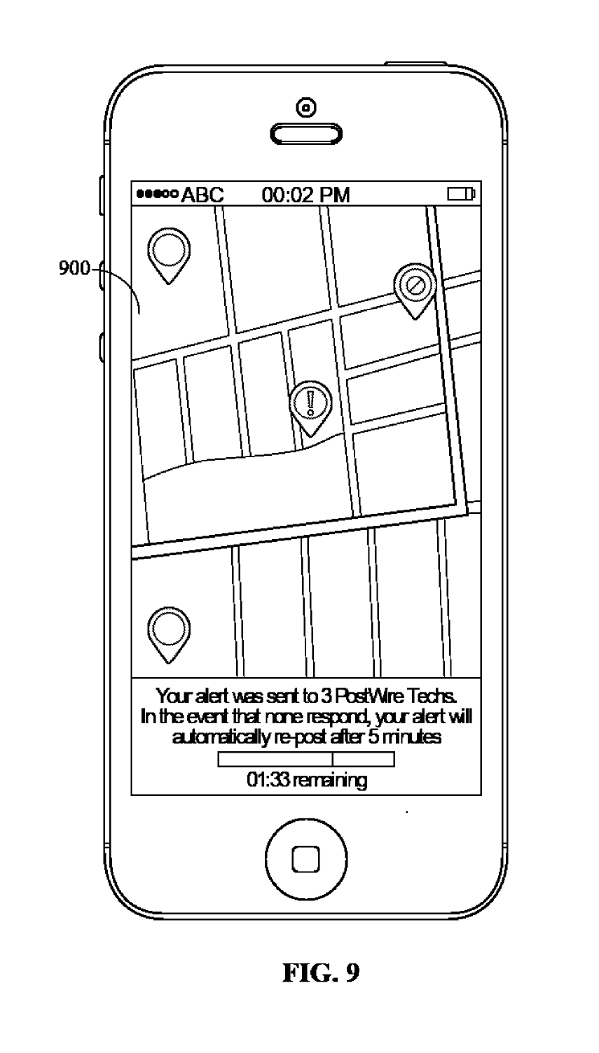

Referring now specifically to FIG. 9, FIG. 9 illustrates a screenshot 900 of the “technician rejected alert request” page that the first technician would receive/see of the Post-Wire install/service mobile application, according to an embodiment of the present invention. The screenshot 900 comprises a timer reflecting amount of time left for the first technician. If a plurality of technicians in an area in vicinity of the first technician reject the one or more requests from the first technician, then the Post-Wire install/service mobile application searches for technicians within a larger distance range.

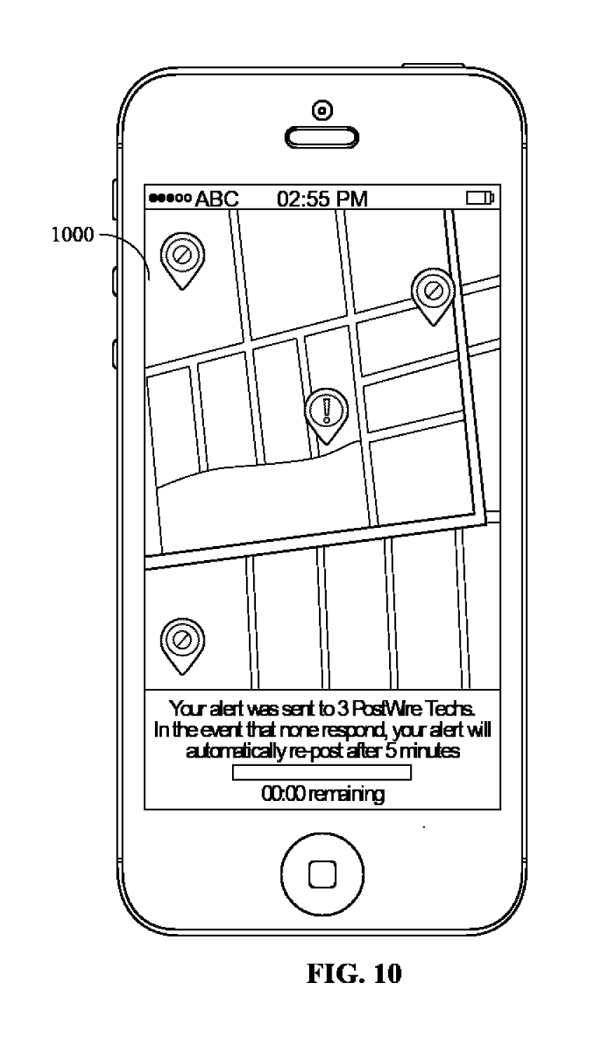

For example, FIG. 10 illustrates a screenshot 1000 of the “all rejection or time-out” page that a first technician would receive/see of the Post-Wire install/service mobile application, according to an embodiment of the present invention. In one example, the first technician is presented with the screenshot 1000 if a timer runs out. In another example, the first technician is presented with a plurality of technicians in a larger area. In one example, the Post-Wire install/service mobile application increases the first distance range from ten miles to twenty miles.

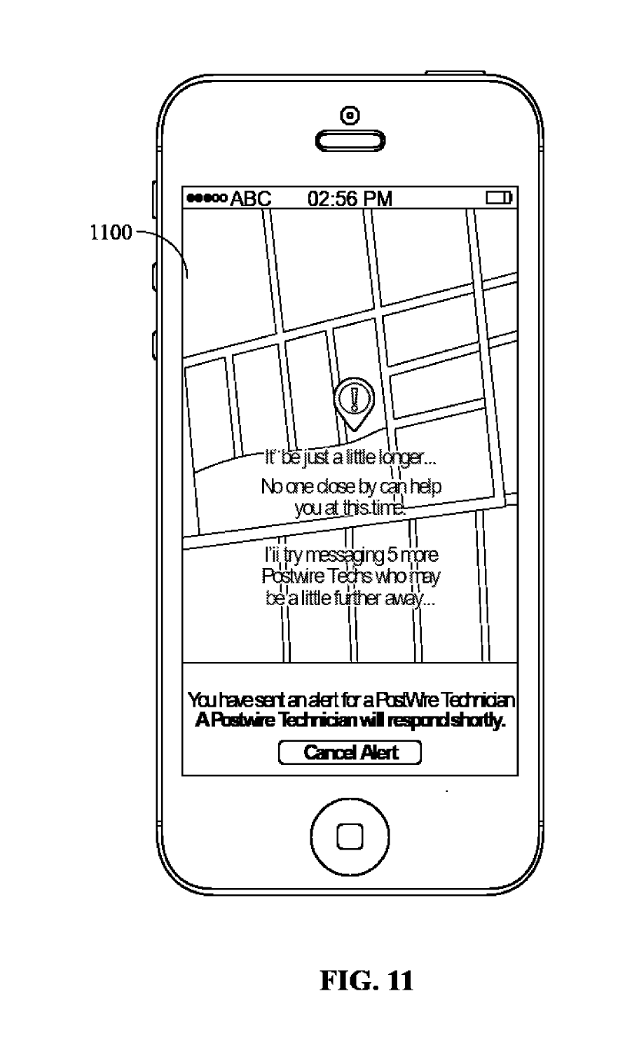

FIG. 11 illustrates a screenshot 1100 of the “larger area request-in-progress” page that the first technician would receive/see of the Post-Wire install/service mobile application, according to an embodiment of the present invention. In one example, the Post-Wire install/service mobile application presents the first technician with five more technicians.

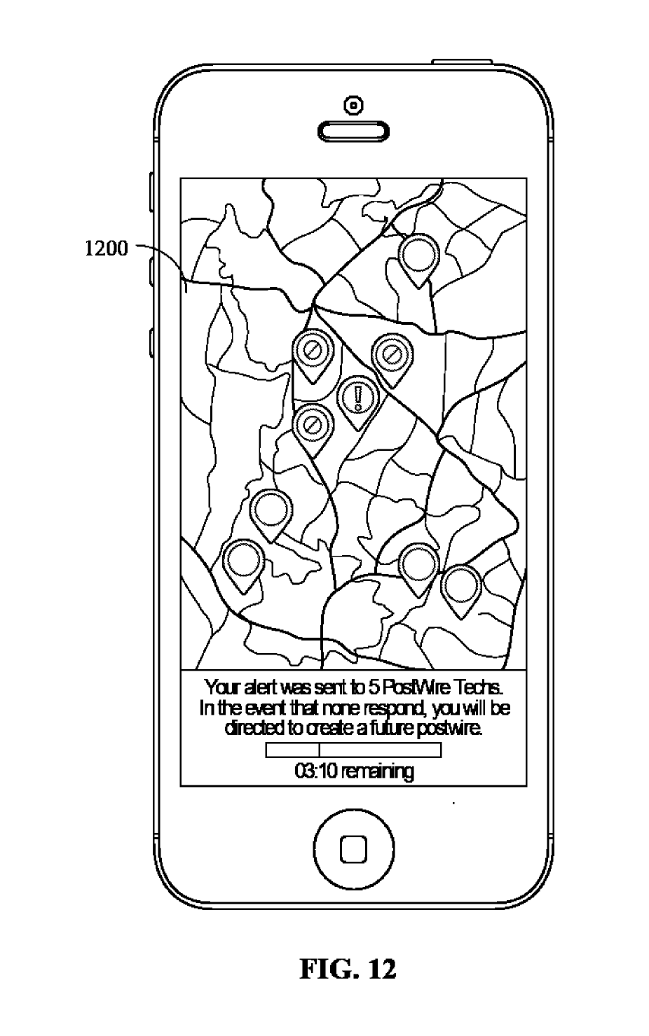

FIG. 12 illustrates a screenshot 1200 of the “larger area request sent” page that the first technician would receive/see of the Post-Wire install/service mobile application, according to an embodiment of the present invention. In another example, a second QC technician is enabled to accept the one or more requests from the first technician. If the plurality of technicians fail to respond to the one or more requests of the first technicians, then the first technician is forwarded to future Post-Wire install/service mobile applications.

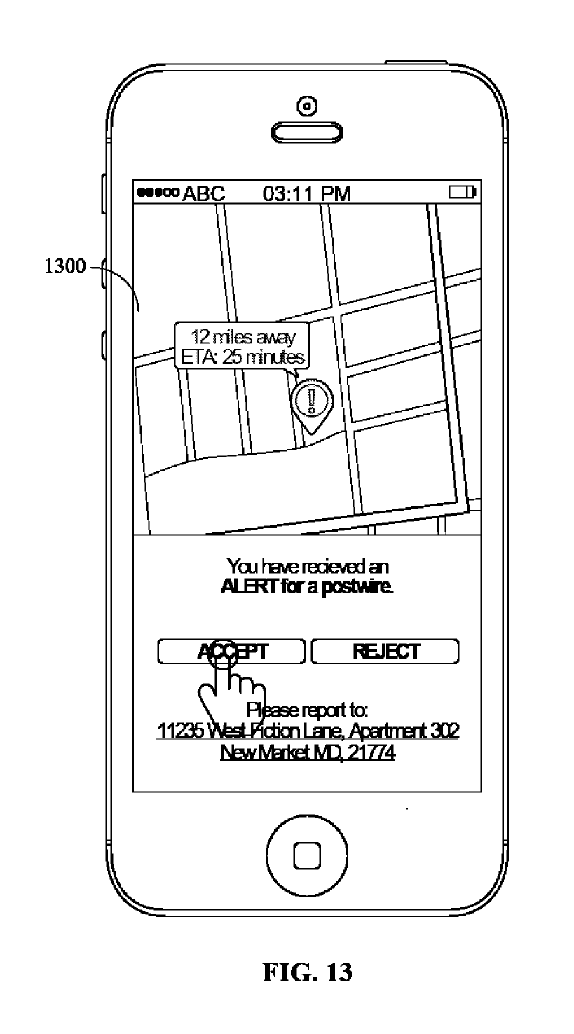

FIG. 13 illustrates a screenshot 1300 of the “accept/reject alert request” page that the second QC post-wire technician would receive/see of the Post-Wire install/service mobile application, according to an embodiment of the present invention. If the second QC post-wire technician clicks on accept, then information about the second QC post-wire technician's decision is relayed to the first technician.

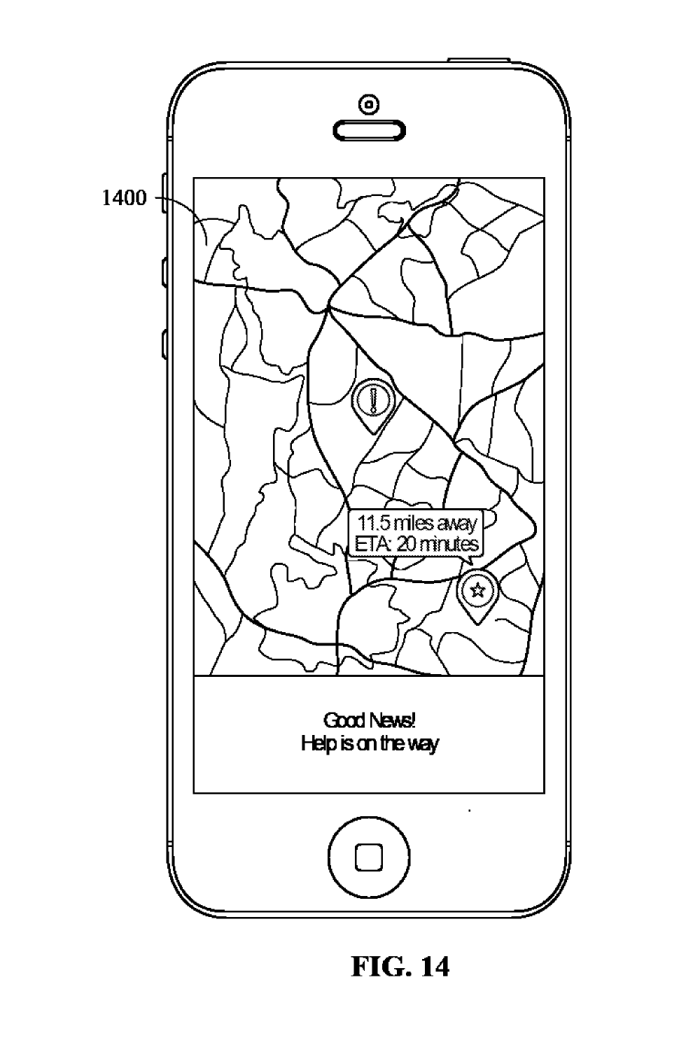

FIG. 14 illustrates a screenshot 1400 of the “technician accept alert request” page that the first technician would receive/see of the Post-Wire install/service mobile application, according to an embodiment of the present invention. The first technician is presented with location of the second QC technician and the estimated time of arrival of the second QC technician.

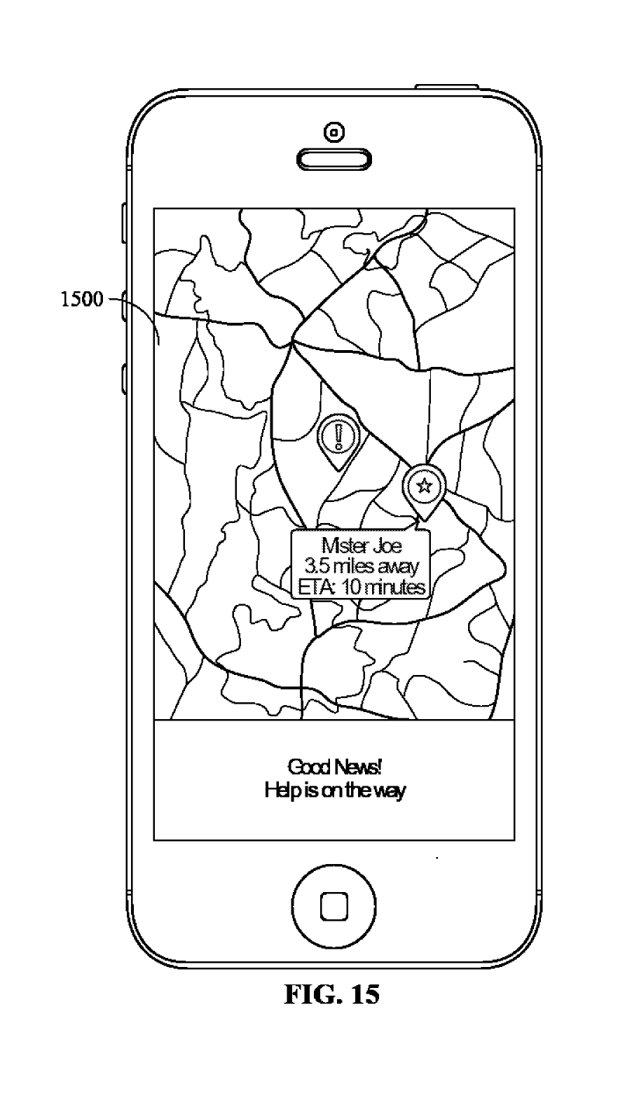

FIG. 15 illustrates a screenshot 1500 of the “assistance-en-route” page that the first technician would receive/see of the Post-Wire install/service mobile application, according to an embodiment of the present invention. In one example, the first technician receives a notification if the second QC technician arrives in the vicinity of the first technician.

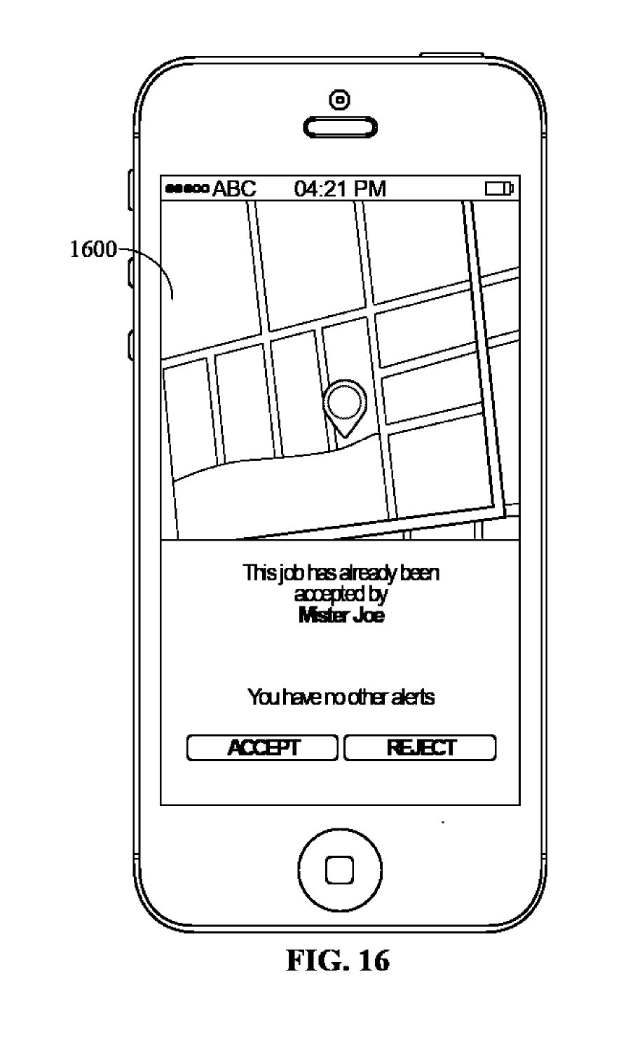

In one example, once the request from the first technician has been accepted by the second QC technician, the plurality of technicians get notification about the request being already accepted. FIG. 16 illustrates a screenshot 1600 of the “alert request already accepted” page that a third QC post-wire technician would receive/see of the Post-Wire install/service mobile application, according to an embodiment of the present invention. The Post-Wire install/service mobile application extracts statistical data about the plurality of users and predicts the responses of the plurality of technicians to the request.

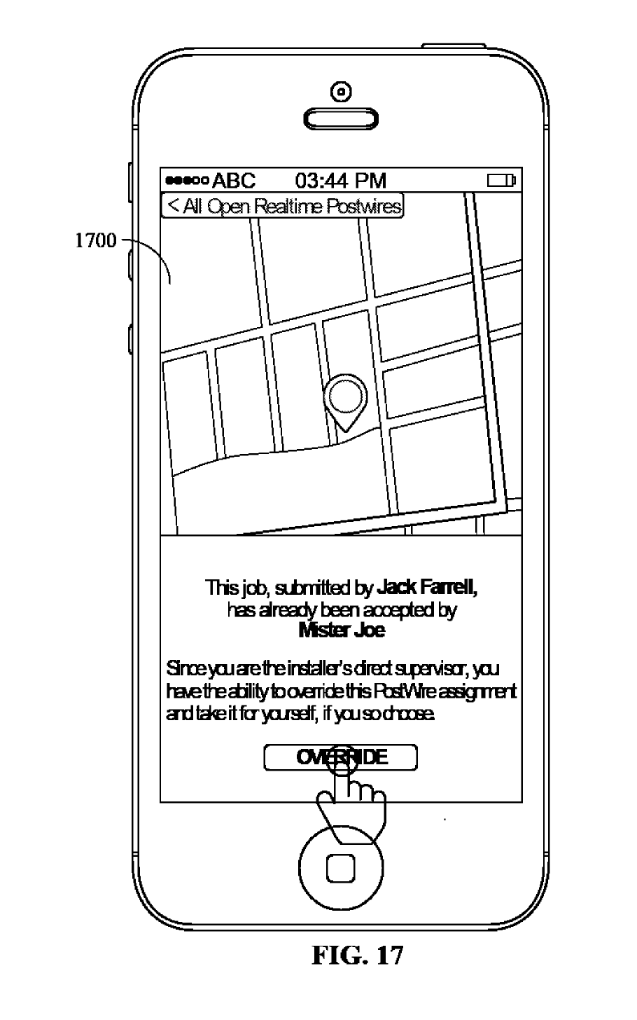

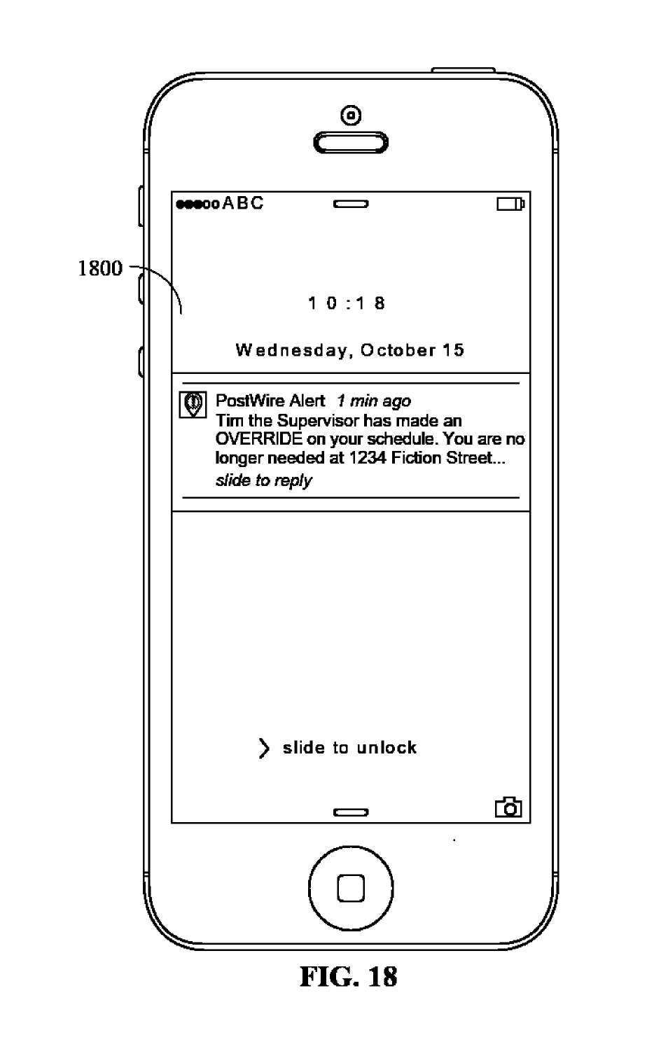

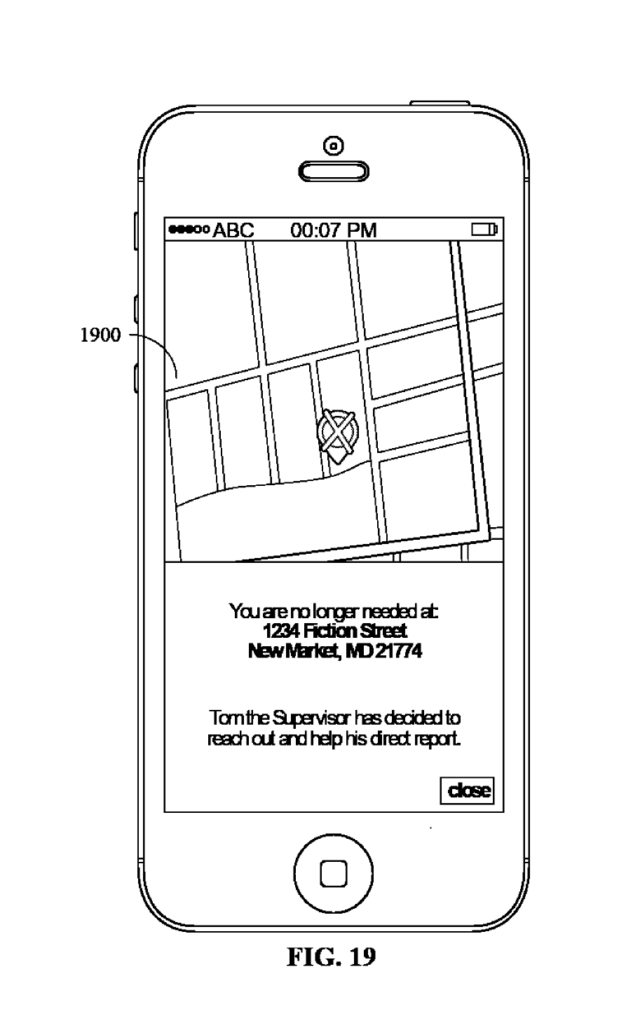

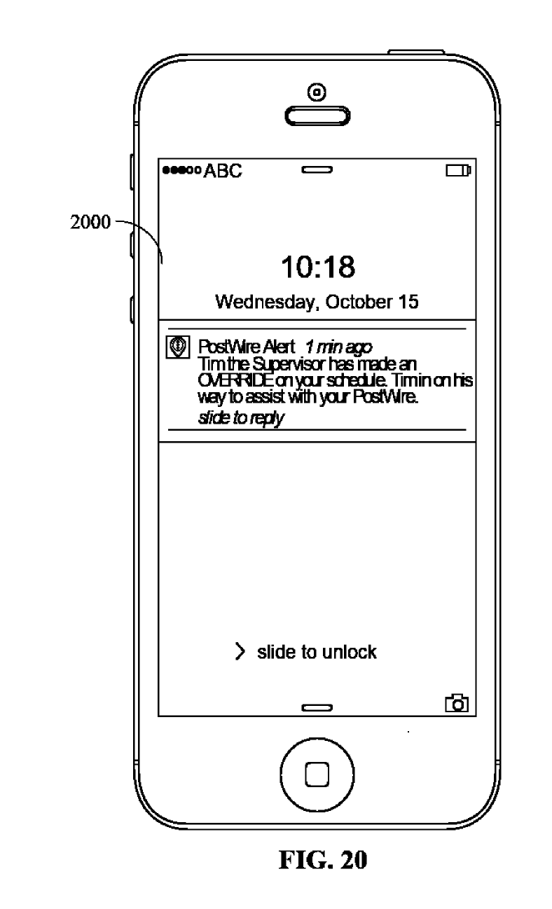

Referring to FIG. 1 again, the set of program modules further comprises an override module 145 configured to reassign the task to a supervisor. The override module 145 generates a “supervisor override” page to enable the supervisor to override decisions of the system. FIG. 17 illustrates a screenshot 1700 of the “supervisor override” page that the supervisor of the first technician would receive/see of the Post-Wire install/service mobile application, according to an embodiment of the present invention. The supervisor is enabled to override the decisions of the system and take the task of dispatching technical assistance to the first technician upon himself. FIG. 18 illustrates a screenshot 1800 of the “supervisor override change” page that the second QC post-wire technician would receive/see of the Post-Wire install/service mobile application, according to an embodiment of the present invention. Both the second QC post-wire technician and the first technician are notified if the supervisor overrides decision of the system. FIG. 19 illustrates a screenshot 1900 of the “supervisor override” page that the second QC post-wire technician would receive/see of the Post-Wire install/service mobile application, according to an embodiment of the present invention. FIG. 20 illustrates a screenshot 2000 of the “supervisor override change” page that the first technician would receive/see of the Post-Wire install/service mobile application, according to an embodiment of the present invention. The first technician is informed of location of the supervisor.

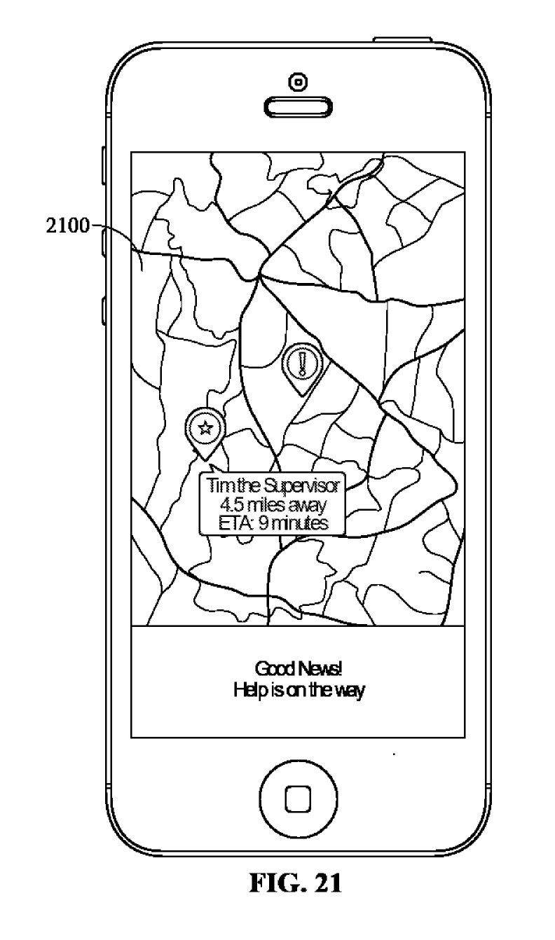

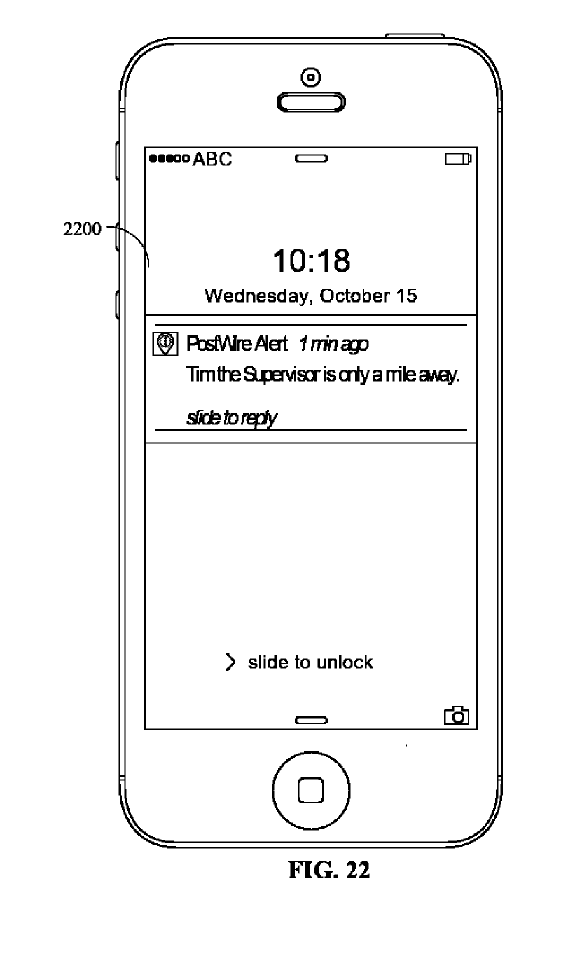

In one example, the location of the supervisor is presented as on a map. For example, FIG. 21 illustrates a screenshot 2100 of the “supervisor assistance-en-route” page that the first technician would receive/see of the Post-Wire install/service mobile application, according to an embodiment of the present invention. Location of the supervisor is depicted on a pictorial map. In one example, the location of the supervisor is notified to the first technician on a home screen. FIG. 22 illustrates a screenshot 2200 of the “supervisor assistance-en-route update” page that the first technician would receive/see of the Post-Wire install/service mobile application, according to an embodiment of the present invention.

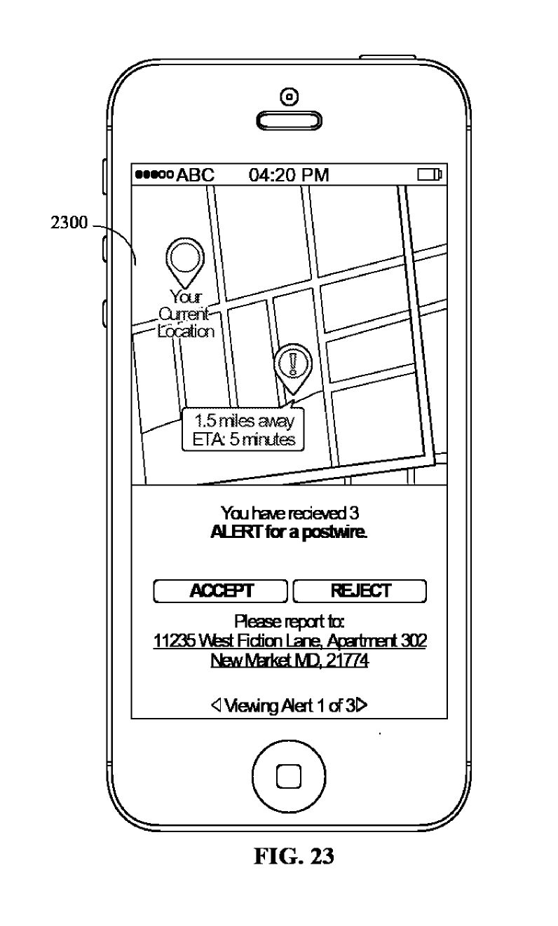

In another example, if the first QC post-wire technician receives a plurality of requests, then the Post-Wire install/service mobile application presents the first technician with the plurality of requests as a stack. For example, FIG. 23 illustrates a screenshot 2300 of the “multiple accept/reject alert request” page that the first QC post-wire technician would receive/see of the Post-Wire install/service mobile application, according to an embodiment of the present invention. If the first QC post-wire technician receives a plurality of requests, then the Post-Wire install/service mobile application presents the first technician with the plurality of requests as a stack. The stack is compared with each other and is sorted in accordance with priority, date, time, and importance.

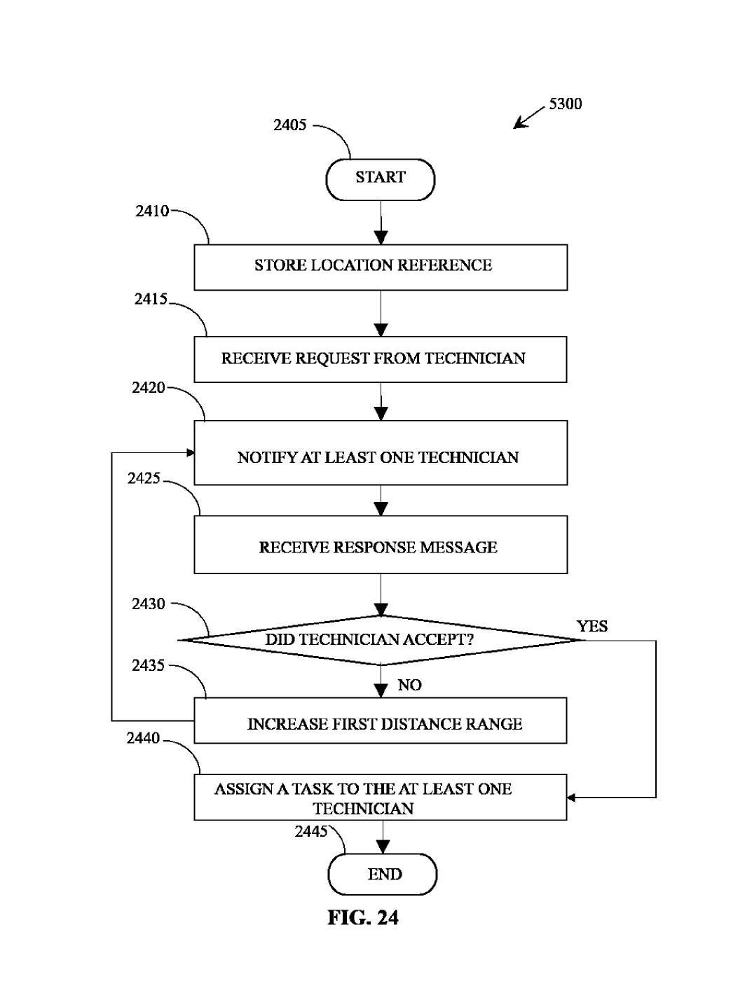

FIG. 24 is a flowchart 2400 of a method of dispatching technical assistance to a technician in accordance with one embodiment of the present invention. The method 2400 is implemented in an environment comprising a first user terminal, a second user terminal and a server. The first user terminal, the second user terminal, and the server are connected with each other via a network. The network is at least one of a Local Area Network, a wide area network, and a mobile network. The environment hosts a system for dispatching technical assistance to a first technician in the server. The first technician and a second technician communicates with the system, via at least one of the first user terminal and the second user terminal. The first user terminal and the second user terminal are at least one of personal computers, laptops, smartphones, tablet computers, and personal digital assistants. In one example, a first portion of the system for dispatching technical assistance is implemented in the first user terminal and the second user terminal as a mobile application. In one example, the mobile application is a Post-Wire install/service mobile application. The method 2400 commences at step 2405.

In one embodiment of the present invention, the server comprises a memory unit and a processor.

At step 2410, the memory unit stores at least one location reference associated with the at least one technician, and a set of program modules. In one example, the memory unit comprises a database. The at least one location reference is at least one of a Cartesian coordinate based location reference and a Global Positioning System (GPS) coordinate based location reference. Further, in one example, the second technician is a post wire technician. The processor executes the set of program modules. The set of program modules comprises an input module and an assistance module.

At step 2410, the input module receives from the first technician, a request for technical assistance, and a first location reference associated with the first technician. The request comprises a description of technical assistance required by the first technician. The description is at least one of a textual description, a visual description, and a vocal description.

At step 2415, if locations referenced by the at least one location reference is within a first distance range from locations referenced by the first location reference, then the assistance module notifies the at least one technician about the request from the first technician. The assistance module notifies the at least one technician via push notification. Further, the assistance module transmits the description of the task to the at least one technician.

At step 2420, the assistance module receives a response message from the at least one technician. The response message comprises one of acceptance by the at least one technician to perform the task and rejection by the at least one technician to perform the task.

At step 2430, the assistance module checks whether if the response message comprises a confirmation. If the response message comprises a confirmation, then the processor executes step 2440 otherwise, the processor executes step 2435.

At step 2435, the assistance module increases the first distance range incrementally, based on the response message comprising rejection to perform the task. Further, the processor executes step 2420 again.

At step 2440, the assistance module assigns the task to the at least one technician, based on the response message comprising acceptance to perform the task.

The method 2400 ends at step 2445.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for dispatching technical assistance to a technician, the system comprising:
a memory unit to store:
at least one location reference associated with the at least one technician, and a set of program modules;
a processor to execute the set of program modules, wherein the set of program modules comprises:
an input module, executed by the processor, configured to:
receive from a first technician,
a request for technical assistance, and
a first location reference associated with the first technician,
wherein the request comprises a description of technical assistance required by the first technician;
an assistance module, executed by the processor, configured to:
notify the at least one technician about the request from the first technician, based on locations referenced by the at least one location reference being within a first distance range from locations referenced by the first location reference,
transmit the description of the task to the at least one technician,
receive a response message from the at least one technician, wherein the response message comprises one of acceptance by the at least one technician to perform the task and rejection by the at least one technician to perform the task,
assign the task to the at least one technician, based on the response message comprising acceptance to perform the task, and
increase the first distance range incrementally, based on the response message comprising rejection to perform the task.

2. The system of claim 1, wherein location references are at least one of a Cartesian coordinate based location reference and a Global Positioning System (GPS) coordinate based location reference.

3. The system of claim 1, wherein the at least one technician is a post wire technician.

4. The system of claim 1, wherein the assistance module notifies the at least one technician via push notification.

5. The system of claim 1, wherein the input module receives the request via at least one user terminal.

6. The system of claim 5, wherein the at least one user terminal is at least one of a computer, a laptop, a palm top, a tablet computer, and a smart phone.

7. The system of claim 1, wherein the set of program module further comprises an override module configured to reassign the task to a supervisor personnel.

8. A computer implemented method for dispatching technical assistance to a technician, the method comprising:
storing in a memory unit, at least one location reference associated with the at least one technician, and a set of program modules;
receiving from a first technician, by the processor via an input module, a request for technical assistance, and a first location reference associated with the first technician, wherein the request comprises a description of technical assistance required by the first technician;
notifying by the processor via an assistance module, the at least one technician about the request from the first technician, based on locations referenced by the at least one location reference being within a first distance range from locations referenced by the first location reference;
transmitting by the processor via the assistance module, the description to the at least one technician;
receiving by the processor via the assistance module, a response message from the at least one technician, wherein the response message comprises one of acceptance by the at least one technician to perform the task and rejection by the at least one technician to perform the task;
assigning, by the processor via the assistance module, the task to the at least one technician, based on the response message comprising acceptance to perform the task; and
increasing by the processor via the assistance module, the first distance range incrementally, based on the response message comprising rejection to perform the task.

9. The method of claim 8, wherein location references are at least one of a Cartesian coordinate based location reference and a Global Positioning System (GPS) coordinate based location reference.

10. The method of claim 8, wherein the at least one technician is a post wire technician.

11. The method of claim 8, wherein the assistance module notifies the at least one technician via push notification.

12. The method of claim 8, wherein the input module receives the request via at least one user terminal.

13. The method of claim 12, wherein the at least one user terminal is at least one of a computer, a laptop, a palm top, a tablet computer, and a smart phone.

14. The method of claim 8, further comprising reassigning, by the processor via an override module, the task to a supervisor personnel.
